(19) United States
(12) Patent Application Publication
(10) Pub. No.: US 2005/0062257 A1
(43) Pub. Date: Mar. 24, 2005

(54) Adjustable placement trailer hitch

(76) Inventor: Mark Donze, Severna Park, MD (US)

Correspondence Address: SUGHRUE MION, PLLC, 2100 PENNSYLVANIA AVENUE, N.W., SUITE 800, WASHINGTON, DC, 20037, US

(21) Appl. No.: 10/667,453

(22) Filed: Sep. 23, 2003

(51) Int. Cl. B60D 1/00

(52) U.S. Cl. 280/490.1

(57) ABSTRACT

A trailer hitch capable of movement in either a horizontal or vertical direction and useful for towing trailers and other towable structures.

### FIELD OF THE INVENTION

This invention relates to hitches that can be used with trailers, cargo containers and the like, including utility trailers, cargo-haulers and horse trailers.

### BACKGROUND OF THE INVENTION

Trailer hitches are well known for enabling connectivity between a towing vehicle and a towed vehicle. For example, trailer hitches are often used between a truck and a horse or utility trailer. The basic hitch is a ball hitch connected to the frame or bumper of the towing vehicle to which the towed vehicle is attached via a receiver.

Many trailer hitch systems are in use today. Some use a “fifth wheel,” or “gooseneck” design wherein the ball is located in the bed of the towing vehicle. Such an arrangement is useful for towing some horse trailers and recreational vehicles. Other hitches are designed to enable interoperability between a ball-type hitch and a non-ball-type hitch (the non-ball-type hitch otherwise known as a “clevis” hitch). The Reese hitch® brand of hitches is especially known for interoperability.

Some hitch arrangements provide for adjusting a height difference between a hitch and a receiver. Examples of such arrangements are disclosed by part numbers PU30029 and PU30056, for example, as advertised on the website, etrailerpart.com, and part number 54977 as advertised at www.reesehitch.com. Such devices are adjustable hitch mounts for vertically adjusting the drop of a hitch by approximately 11 inches, or raising a hitch approximately 9 and ⅝ inches, from the point at which the devices are attached to the bumper.

Disadvantages for such adjustable hitch mounts are many, however. For instance, the devices are restricted to the miniscule range of less than a foot of adjustment either up or down. Additionally, such devices can only be adjusted in approximately two inch increments. Moreover, the devices cannot be attached to the trailer's receiver while such devices are adjusted.

Additional problems of the conventional systems include the hitch and receiver sometimes being located at different planes of vertical height, making connectivity difficult and especially dangerous or even impossible when the trailer is heavy or loaded with cargo. In other instances, the trailer may be attached to the hitch, but the trailer being towed needs the tongue of its frame either lowered or raised. For example, in loading/unloading situations or those situations requiring the cargo to travel at a particular angle on the bed of the trailer, it would be advantageous to be able to raise or lower the tongue of the trailer without disconnecting the trailer'receiver from the vehicle's hitch.

### SUMMARY OF THE INVENTION

Accordingly, it is a general object of the present invention to provide a trailer hitch system which overcomes all of the disadvantages described above and other disadvantages of the prior art.

It is also an object of the present invention to provide a connection device for connecting a towable structure to a vehicle capable of towing, the connection device including a body; an attachment portion for attaching the body of the connection device to the vehicle capable of towing; a housing capable of movement in a direction coaxial to an axis created by the lengthwise direction of a mast; gears integrally connected to both the housing and said mast, the gears capable of moving said housing in at least two directions and also maintaining continual contact between the housing and the mast while the housing is moved by the gears; and a trailer hitch connected to the housing, said trailer hitch capable of connection to the towable structure.

It is a further object of the present invention to provide a connection device with at least one of a hand crank, an electric motor, a hydraulic or pneumatic device.

It is yet an additional object of the present invention to provide a connection device with a trailer hitch that is at least one of a ball hitch, a non-ball-type hitch, and a receiver for a hitch.

It is still another object of the present invention to provide a connection device with a mast and housing that are capable of separation from an attachment portion.

It is another object of the present invention to provide a connection device with a mast and housing that attach to an attachment portion with a locking pin.

It is yet a further object of the present invention to provide an attachment portion with a tongue which indexes into a hitch receiver, wherein the hitch receiver is capable of attachment to a towing vehicle.

It is still an additional object of the present invention to provide a housing capable of movement in either a substantially horizontal and/or a substantially vertical direction, with a range of movement from zero to within approximately five feet.

It is another object of the invention to provide a connection device for connecting a towable structure to a vehicle capable of towing, the connection device comprising a body; an attachment portion for attaching the body of the connection device to the vehicle capable of towing; a mast; a housing; movement means for moving the housing in a direction coaxial to an axis created by the lengthwise direction of the mast; wherein the movement means is integrally connected to both the housing and the mast, and is further capable of moving the housing in at least two directions; and a trailer hitch connected to the housing, the trailer hitch capable of connection to the towable structure.

### BRIEF DESCRIPTION OF THE DRAWINGS

The invention, both as to its organization and manner of operation, may be further understood by reference to the drawings that include FIGS. 1-4, taken in connection with the following descriptions:

FIG. 1 is an illustration of a non-limiting embodiment of the invention wherein a trailer hitch portion is in a non-extended state;

FIG. 2 is an example of a trailer hitch in accordance with an embodiment of the invention wherein a trailer hitch portion is in an extended state;

FIG. 3 depicts a non-limiting, exemplary embodiment of a gear system in accordance with an embodiment of the invention showing mechanical operability to move a trailer hitch portion from a non-extended, to an extended, state; and

FIG. 4 is a depiction in accordance with an embodiment of the invention wherein a receiver of a trailer is attached to a trailer hitch portion.

### DETAILED DESCRIPTION OF PREFERRED EMBODIMENTS OF THE INVENTION

The following description of illustrative non-limiting embodiments of the invention discloses specific configurations and components. However, the embodiments are merely examples of the present invention, and thus, the specific features described below are merely used to describe such embodiments and to provide an overall understanding of the present invention. Accordingly, one skilled in the art will readily recognize that the present invention is not limited to the specific embodiments described below. Furthermore, the descriptions of various configurations and components of the present invention that are known to one skilled in the art are omitted for the sake of clarity and brevity.

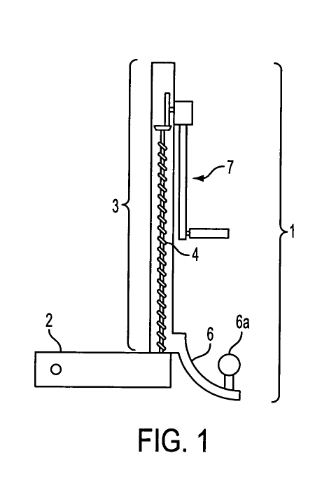

FIG. 1 is an illustration of an embodiment of the invention wherein the connection device body 1 is in a non-extended state. As shown in the figure, a connection device body 1 includes an attachment, or tongue portion, 2; a housing 3; gears 4; a tail 6; a ball 6a; and a crank 7. Any of these features may comprise metal, composite materials, alloy, ABS, hardened polyurethane, polyvinyl, PVC, and/or other extruded, molded, cast or die-cast materials providing appropriate structure.

The tongue portion 2 is a structural member typically fashioned of tubular or square pipe, enabling connectivity between the body 1 and a hitch receiver (the hitch receiver is not shown), wherein the hitch receiver is integrally attached to a vehicle capable of towing.

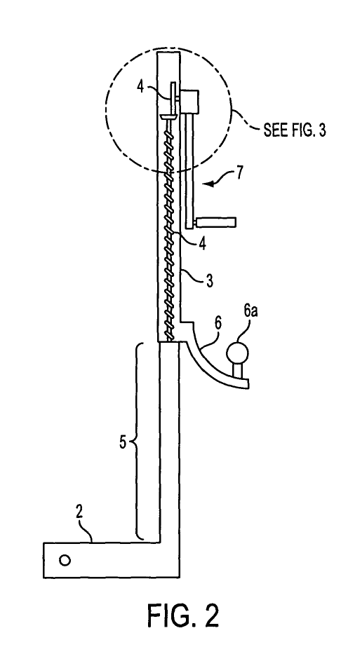

FIG. 2 illustrates a further embodiment of the invention wherein the connection device body 1 is in an extended state. As shown in the figure, the mast 5 is integrally attached to the structural member including the tongue portion 2. The mast 5 in one embodiment is a square, metal, tubular structure.

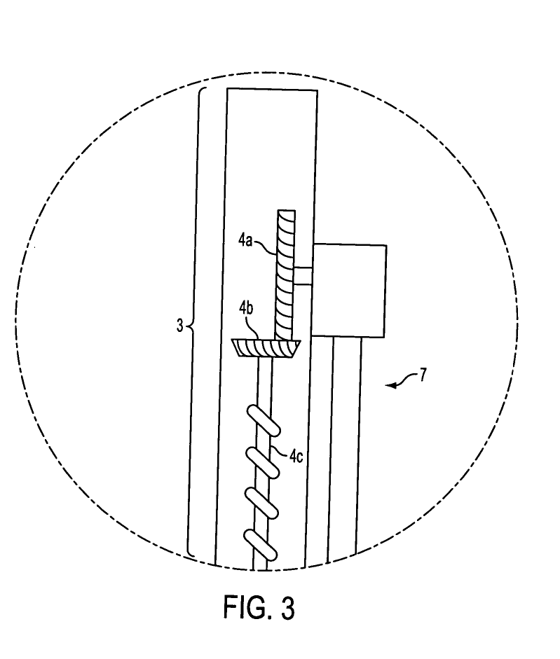

Within the mast 5 are arranged a number of gears, for example, gears 4a-c (the gears 4a-c are shown in greater detail in FIG. 3). The gears 4a-c are interconnected and additionally connect the mast 5 to the hitch-lift housing 3 such that when the gears are operated, the hitch-lift housing 3 is enabled to move in at least two directions.

In the figures, the hitch-lift housing 3 is shown to move in substantially a vertical direction. The hitch-lift housing 3 may move either up or down vertically. Such vertical movement, when a trailer is attached to the adjustable placement trailer hitch 1, causes the rear-most portion of the attached trailer to move in a direction opposite to the direction in which the hitch-lift housing 3 moves because the trailer acts as a fulcrum. That is, when the hitch-lift housing 3 moves up, the rear-most end of an attached trailer moves down. Further, when the hitch-lift housing 3 moves down, the rear-most end of an attached trailer moves up. While the embodiments shown in the figures display approximate ranges of adjustment, it is readily recognized by one of ordinary skill in the art that it is possible to enable the adjustment of the device to range from ground level to many feet high.

Further, as would be readily recognized by one of ordinary skill in the art, the hitch-lift housing 3 and mast 5 could be constructed so as to operate in a substantially horizontal direction or even in both vertical and horizontal directions. Structurally, the hitch-lift housing 3 is a female member generally containing most or all of the mast 5 in a non-extended state and much less of the mast 5 in an extended state. Additionally, the gears 4 are also contained within the hitch-lift housing 3 (as well as the mast 5). Moreover, hitch-lift housing 3 is integrally attached to the tail 6, as further described herein.

The hand crank 7 is a mechanical device integral with the gears 4 which transfers a circular, cranking motion to the mechanical, gear-driven energy which moves the hitch-lift housing 3 in at least one of two directions. While the hand crank 7 is depicted as a human labor device, it would be clear to one of ordinary skill in the art that the device 7 may be readily adapted to be operated or replaced with one of an electric motor, a hydraulic device, a pneumatic device, or another method for transferring energy to the hitch-lift housing 3 so as to enable movement.

The tail 6 and ball 6a are integrally attached to the hitch-lift housing 3, such that when the hitch-lift housing 3 is moved in any direction, the tail 6 and accompanying ball 6a follow in lock-step fashion. Accordingly, when the hitch-lift housing 3 is moved, the tail 6 and ball 6a move an identical amount in the same direction. While element 6a is shown as a ball, one of ordinary skill in the art would readily recognize that element 6a could be a clevis hitch or a receiver for a hitch, enabling various forms of connectivity.

FIG. 3 depicts a non-limiting embodiment of the invention including gears 4a-c. The gear 4a is attached to the hitch-lift housing 3 and the gear 4c is attached to the mast 5. Both the gear 4a and the gear 4c are attached to crown gear 4b. The crown gear 4b is an energy transfer element, transferring energy in the form of geared rotation from the hand crank device 7 to the gears 4a and 4c, thus enabling the movement of the hitch-lift housing 3 in at least two directions. While the gears 4a-c are shown in FIG. 3 as a drive gear, a crown gear, and a screw shaft, respectively, it would be readily recognized by one or ordinary skill in the art that the gears 4a-c may be other forms of gears or other energy-transference devices capable of transferring the energy provided by element 7 to the hitch-lift housing 3, enabling movement in at least two directions.

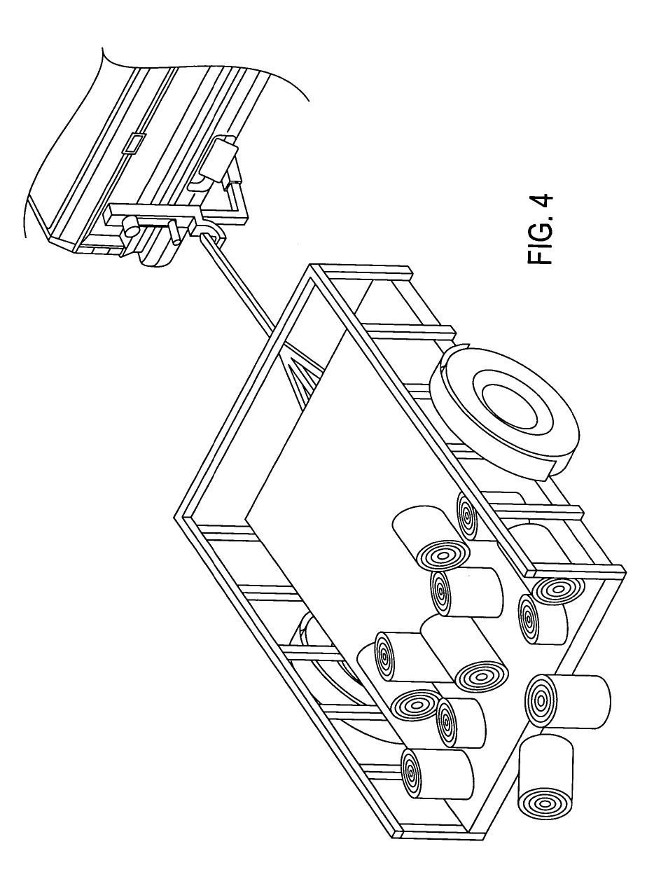

FIG. 4 is a depiction of an embodiment of the invention showing the invention in an extended state. That is, the hitch-lift housing 3 is partially extended above the mast 5. Attached to the tail 6 is the receiver of a trailer. As depicted, the trailer's bed is provided with an oblique angle due to the raised hitch-lift housing 3, thus enabling the easy offload of the cargo contained on the trailer bed.

The above embodiments clearly have various advantages over the prior art. Advantageous characteristics in the embodiments of the present invention include: simplicity of design; cost-effectiveness in view of the previous; a fail-safe design; such structure so as to enable the raising or lowering of a trailer hitch to allow quick, safe and easy connectivity between hitches and receivers that are initially located at different planes of vertical height; the ability to raise or lower the trailer hitch while the hitch is connected to the receiver tongue of a trailer, thus enabling the raising or lowering of a trailer bed without disconnecting the trailer hitch; and providing a greater range of adjustment than the prior art.

The previous description of the preferred embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. For example, some or all of the features of the different embodiments discussed above may be deleted from the embodiment. Therefore, the present invention is not intended to be limited to the embodiments described herein but is to be accorded the widest scope defined only by the claims below and equivalents thereof.

1. A connection device for connecting a towable structure to a vehicle capable of towing, said connection device comprising:
a body;
an attachment portion for attaching the body of the connection device to the vehicle capable of towing;
a housing capable of movement in a direction coaxial to an axis created by the lengthwise direction of a mast;
gears integrally connected to both said housing and said mast, said gears capable of moving said housing in at least two directions, said gears maintaining continual contact between said housing and said mast while said housing is moved by said gears; and
a trailer hitch connected to said housing, said trailer hitch capable of connection to the towable structure.

2. The connection device of claim 1, further wherein said gears are driven by at least one of: a hand crank, an electric motor, a hydraulic device or a pneumatic device.

3. The connection device of claim 1, further wherein said trailer hitch is at least one of a ball-type hitch, a non-ball-type hitch, and a receiver for a hitch.

4. The connection device of claim 1, further wherein said housing and said mast are capable of separation from said attachment portion.

5. The connection device of claim 4, further wherein said housing and said mast attach to said attachment portion with a locking pin.

6. The connection device of claim 1, further wherein said attachment portion is a tongue which indexes into a hitch receiver, said hitch receiver capable of connection to the vehicle capable of towing.

7. The connection device of claim 1, further wherein said housing possesses a range of movement from substantially zero to substantially five feet.

8. The connection device of claim 7, wherein the range of movement ranges from substantially zero to less than five feet.

9. The connection device of claim 1, wherein said housing is capable of movement in a vertical direction.

10. The connection device of claim 1, wherein said housing is capable of movement in a horizontal direction.

11. A connection device for connecting a towable structure to a vehicle capable of towing, said connection device comprising:
a body;
an attachment portion for attaching the body of the connection device to the vehicle capable of towing;
a mast;
a housing;
movement means for moving said housing in a direction coaxial to an axis created by the lengthwise direction of said mast;
said movement means integrally connected to both said housing and said mast, said movement means being capable of moving said housing in at least two directions; and
a trailer hitch connected to said housing, said trailer hitch capable of connection to the towable structure.

12. The connection device of claim 11, further wherein said movement means include a device driven by at least one of: a hand crank, an electric motor, hydraulics or pneumatics.

13. The connection device of claim 11, further wherein said trailer hitch is at least one of a ball-type hitch, a non-ball-type hitch, and a receiver for a hitch.

14. The connection device of claim 11, further wherein said housing and said mast are capable of separation from said attachment portion.

15. The connection device of claim 14, further wherein said housing and said mast attach to said attachment portion with a locking pin.

16. The connection device of claim 11, further wherein said attachment portion is a tongue which indexes into a hitch receiver, said hitch receiver capable of connection to the vehicle capable of towing.

17. The connection device of claim 11, further wherein said housing possesses a range of movement from substantially zero to substantially five feet.

18. The connection device of claim 17, wherein the range of movement ranges from substantially zero to less than five feet.

19. The connection device of claim 11, wherein said housing is capable of movement in a substantially vertical direction.

20. The connection device of claim 11, wherein said housing is capable of movement in a substantially horizontal direction.
